(19) United States
(12) Patent Application Publication
(10) Pub. No.: US 2015/0172096 A1
(43) Pub. Date: Jun. 18, 2015

(54) SYSTEM ALERT CORRELATION VIA DELTAS

(71) Applicant: Microsoft Corporation, Redmond, WA (US)

(72) Inventors: Art Sadovsky, Bellevue, WA (US); Jon Avner, Bellevue, WA (US)

(73) Assignee: Microsoft Corporation, Redmond, WA (US)

(21) Appl. No.: 14/109,866

(22) Filed: Dec. 17, 2013

(51) Int. Cl. H04L 12/24; G06N 99/00; H04L 29/08

(52) U.S. Cl. CPC H04L 41/0631; H04L 67/10; G06N 99/005

(57) ABSTRACT

Technologies are generally provided for correlation of system alerts via deltas. Alert pairs may be generated by comparing each alert to the alerts surrounding it in time, up to a particular time window. The deltas for each pair may then be computed, and those sets of deltas analyzed to determine difference values in numeric terms. A threshold may be applied to the numeric values and alerts within a certain distance of each other may be considered to represent a correlation. Each alert may then be provided with all other related alerts, thus reducing a monitoring noise and making identification of the root cause of the alerts easier.

### BACKGROUND

In any highly available complex distributed system, such as a cloud-based email service, one of the key aspects of system maintenance is to monitor the health status of the system to ensure the system is indeed available. The monitoring may be highly complex and noisy due to many alerts being issued from many different hardware and software components. Often, a single root cause issue may generate more than a single alert, and sometimes many alerts may be generated from many different components. Processing such alerts, either manually or automatically, may be difficult, costly, and possibly self-defeating if the alerts are treated individually.

Correlating multiple related alerts together in a complex distributed system may be used to ensure each root cause is identified and addressed more quickly and correctly. Typical approaches for such correlations may include treating each alert as a point in n-dimensional space and using a clustering or other machine-learning technique to identify relationships. This may be difficult because not all substantial properties may be easily characterized with a numeric value. Furthermore, as system characteristics change, clusters formed previously may not create good rules that generalize for the future.

### SUMMARY

This summary is provided to introduce a selection of concepts in a simplified form that are further described below in the Detailed Description. This summary is not intended to identify exclusively key features or essential features of the claimed subject matter, nor is it intended as an aid in determining the scope of the claimed subject matter.

Embodiments are directed to correlation of system alerts via deltas, which are measurements of “distance” or “similarity” between alerts. In some examples, alert pairs may be produced by comparing each alert to the alerts surrounding it in time, up to a particular time window. The deltas for each pair may then be computed, and those sets of deltas analyzed to determine difference values in numeric terms. A threshold may be applied to the numeric values and alerts within a certain distance of each other may be considered to represent a correlation. Each alert may then be provided with all other related alerts, thus reducing a monitoring noise and making identification of the root cause of the alerts easier.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 illustrates an example cloud-based environment, where alerts may be analyzed through correlation using deltas;

FIG. 2 illustrates conceptually computation of a delta for two example alerts;

FIG. 3 illustrates a block diagram for correlation of alerts via computation of deltas for alert pairs and comparison to a threshold;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of correlating system alerts via deltas, according to embodiments.

### DETAILED DESCRIPTION

As briefly described above, a system is provided for monitoring system alerts in a complex, distributed system with a high number of components. Alert pairs may be generated by comparing each alert to the alerts surrounding it in time. The deltas for each pair may then be computed, and those sets of deltas analyzed to determine difference values in numeric terms. The numeric value may be compared to a threshold to find alerts within a certain distance of each other that may be considered to represent a correlation.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for analyzing system alerts through correlation using deltas. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

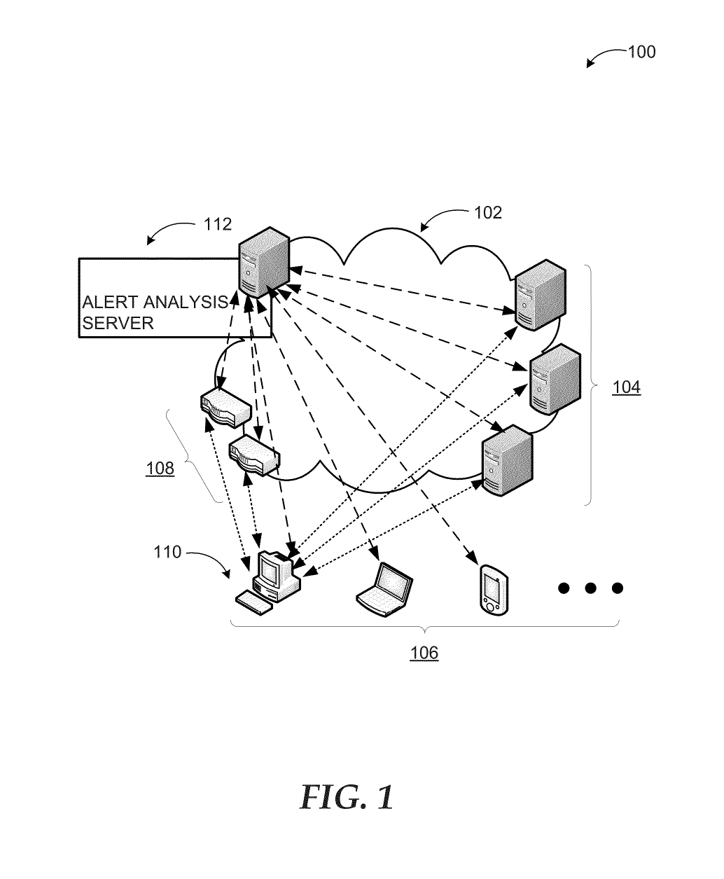

FIG. 1 illustrates an example cloud-based environment, where alerts may be analyzed through correlation using deltas, according to some embodiments.

As demonstrated in diagram 100, a distributed service such as a cloud-based email service may include a number of components like servers 102, special purpose devices 108, and similar ones. These servers and special purpose devices may perform various tasks individually or in shared manner. Some servers may be general purpose servers taking different roles under different circumstances, while others may be dedicated servers performing specific tasks. For example, some servers may manage subscriber profiles; others may be presence servers, directory servers, and the like. Subscribers of the service may access the service through a variety of client devices 106. In addition to the hardware components, a service as described herein may also involve a high number and variety of software components. Moreover, each subscriber (e.g., client device 110) may interact with each component of the service.

Thus, a distributed service may need to monitor and ensure seamless operation of its hardware and software components in order to maintain subscriber satisfaction. With the high number and variety of components (and client devices), the monitoring may be highly complex and noisy due to many alerts being issued from many different hardware and software components. Processing such alerts, either manually or automatically, may be difficult, costly, and possibly self-defeating if alerts associated with the same root cause are treated individually.

In a system according to embodiments, alerts may be dealt with as pairs, rather than treat such items individually, and using the deltas between pairs of alerts as the data to be analyzed by machine-learning techniques. Deltas may be measurements of “distance” or “similarity” between alerts. While absolute numeric values are often difficult to assign, relative numeric values are easier. For example, if the machine that generated an alert is to be included in the analysis, an absolute schema may involve each machine to be numbered such that the bigger the difference between the numbers indicating the less likely a relationship existed, or each machine may have to be made its own dimension and have a possible value of 0 or 1. In the relative case, the difference between the machine property for two alerts may simply be 0 if they are the same and 1 if they are different (or the difference may be greater or lower depending on a distance metric).

Thus, in a system according to embodiments, an analysis server 112 may receive alerts from different components of the service, as well as, the client devices over one or more networks 102 and analyze the alerts using the deltas between pairs of alerts employing machine-learning techniques.

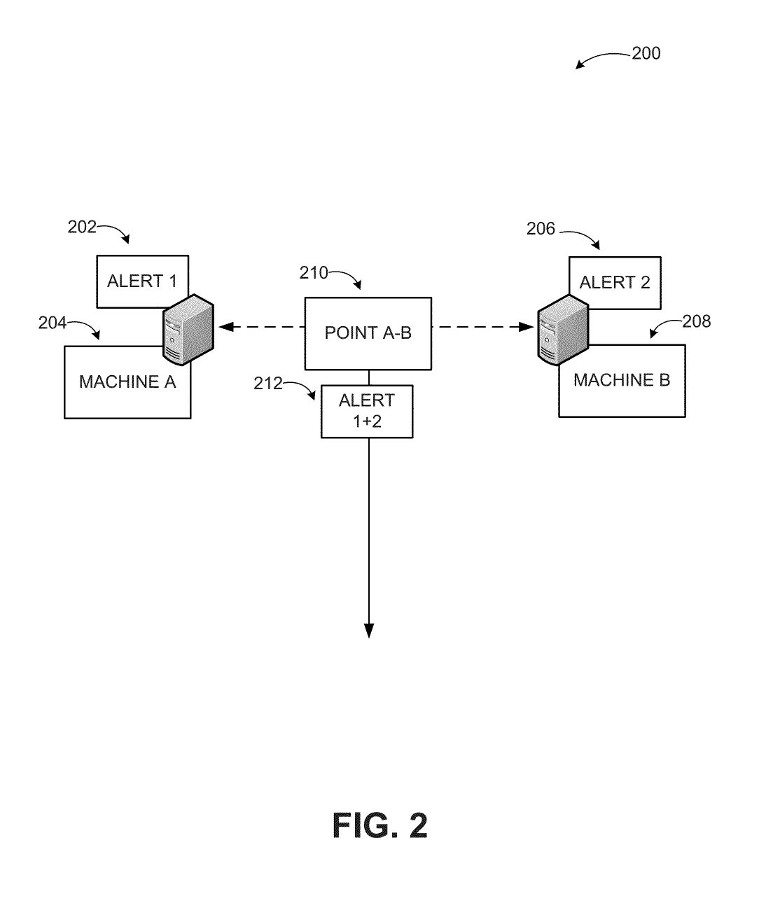

FIG. 2 illustrates conceptually computation of a delta for two example alerts according to some embodiments.

Alert pairs may be produced by comparing each alert to the other alerts surrounding each alert in time, up to a particular time window. The deltas for each pair may then be computed, and those sets of deltas analyzed to determine difference values in absolute numeric terms. A threshold may then be applied and alerts within a certain distance may be considered to represent a correlation. Each alert may then be provided with other related alerts, thus reducing the monitoring noise and making root cause identification easier. Alert correlations may also be used to actually suppress redundant alerts rather than simply report on them. In this way, redundant alerts may not reach an end user unnecessarily. Moreover, alerts may be handled manually or automatically. The correlation logic described herein may be implemented in either case.

Focusing on hardware components, diagram 200 shows two different machines (e.g., servers, special purpose devices, etc.) 204 and 208 issuing two distinct alerts 202 and 206. The alerts 202 and 206 may be related (of the same root cause) or not. In a system according to embodiments, an analysis server may analyze the delta of the alerts and discern if the alerts are tied to the same issue. Instead of analyzing individual machines and alerts, the analysis server may identify pairs of alerts 212 and points 210 between the machines issuing those alerts.

As shown in diagram 200, instead of alert 202 from machine 204 and alert 206 from machine 208, alerts (A+B) 212 at point 210 between the machines 204 and 208 may be used by the analysis server. Then, a decision may be made if machines can be considered the same from the alert perspective (same root cause). If they are, a 0 value may be assigned, if not a 1 value may be assigned simplifying the analysis process. Of course, other approaches may also be used to identify alert pairs and their origination points. Embodiments are not limited to alerts issued by hardware components. Alerts may be issued (and analyzed as described herein) by hardware components, software components, and any combination of the two. In some examples, comparisons of properties may be relatively simple (e.g., if they are equal, the difference is 0; if they are not equal, the difference is 1) or highly complex (e.g., using sophisticated natural language techniques to analyze the similarity of free form text).

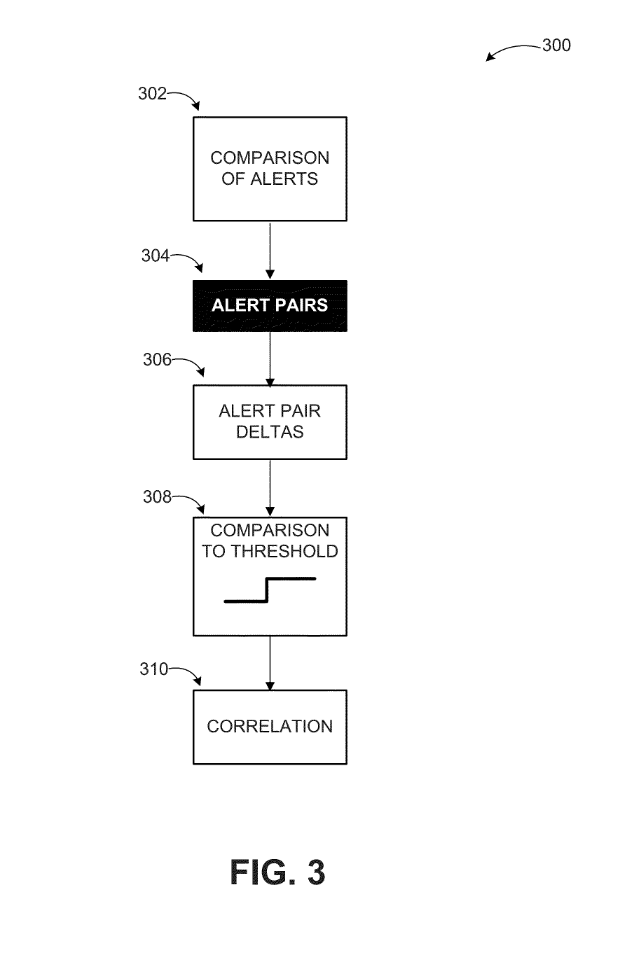

FIG. 3 illustrates a block diagram for correlation of alerts via computation of deltas for alert pairs and comparison to a threshold according to some embodiments.

Diagram 300 presents an overview of an alert analysis process using deltas. The process may begin with a comparison of alerts 302 resulting in alerts pairs 304. Alert pair deltas 306 may then be computed and compared to a threshold (308). The values exceeding the threshold may be used to determine correlation 310 between alerts.

To generate and analyze deltas, alerts generated by a system may be funneled into one place. That place may needs to be scalable enough to take the monitoring load while performing the computations described herein. In other embodiments, the data may also be partitioned and analyzed based on the partitions. Upon receipt of an alert, an analysis server may perform the following actions: (1) Find the alerts in the previous time window (e.g., 1 hour, 1 day, etc.). (2) Compare the pertinent properties in each of these alerts to the new alert. For each property pair, a numeric delta may be computed. Typically, each delta may have the same range (e.g., between 0 and 1, with 0 indicating the properties are identical and 1 indicating a maximum the properties can differ by). (3) Each property may have a weight associated with it that determines how important that property is. Weights may be learned according to some embodiments, for example, using gradient descent algorithm. (4) Given a set of weights and a set of deltas, a difference value may be computed in a number of ways. Euclidean distance and a sigmoidal function are two examples. Other correlation approaches may also be used. The result of the difference value computation may be a normalized value between 0 and 1, with 0 indicating identical alerts and 1 indicating alerts that have no similarities at all. (5) A threshold may to be determined, either manually or through other machine-learning algorithms. The threshold may indicate what value may be the maximum value that may still be considered as identifying a possible relationship between the alerts. (6) Each found relationship may be stored in a database or similar data store. (7) When an alert is either sent to a support engineer for manual processing or handled automatically by a repair service, the related alerts may also be provided as a group rather than forcing the support engineer or service to deal with the alerts individually.

In some embodiments, direct user feedback may be received on whether or not the correlation is valid, and the feedback used to improve the machine-learning algorithm. In other embodiments, various techniques may be employed to infer user feedback from user interactions with the system in order to determine whether a presented correlation was valid or not.

The example applications, devices, and modules, depicted in FIGS. 1-3 are provided for illustration purposes only. Embodiments are not limited to the configurations and content shown in the example diagrams, and may be implemented using other algorithms, configurations, client applications, service providers, and modules employing the principles described herein

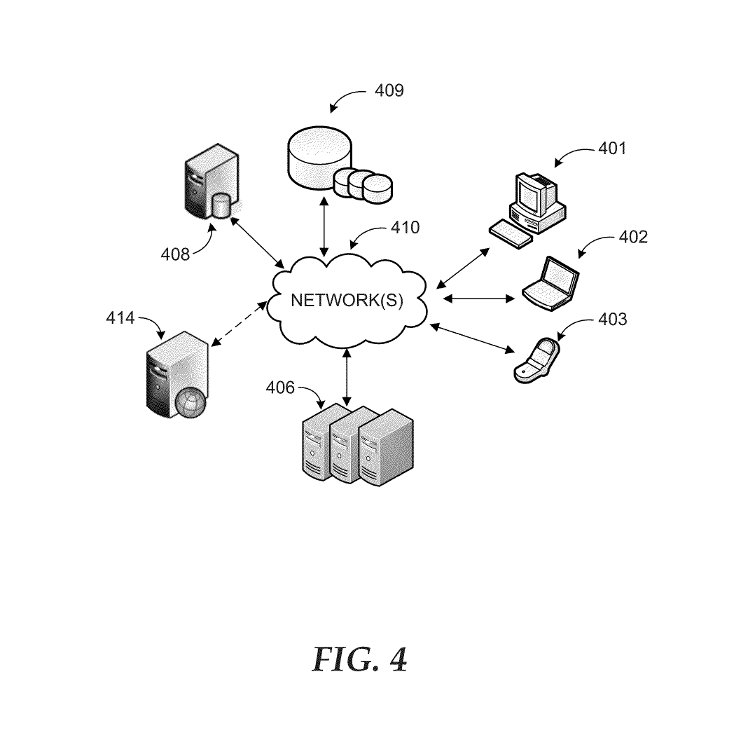

FIG. 4 is an example networked environment, where embodiments may be implemented. In addition to locally installed applications, alert analysis based on deltas may also be deployed in conjunction with hosted applications and services that may be implemented via software executed over one or more servers 406 or individual server 414. A hosted service or application may communicate with client applications on individual computing devices such as a handheld computer, a desktop computer 401, a laptop computer 402, a smart phone 403, a tablet computer (or slate), (‘client devices’) through network(s) 410 and control a user interface presented to users.

Client devices 401-403 may be used to access the functionality provided by the hosted service or application. One or more of the servers 406 or server 414 may be used to provide a variety of services as discussed above. Relevant data may be stored in one or more data stores (e.g. data store 409), which may be managed by any one of the servers 406 or by database server 408.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 may also coordinate communication over other networks such as PSTN or cellular networks. Network(s) 410 provides communication between the nodes described herein. By way of example, and not limitation, network(s) 410 may include wireless media such as acoustic, RF, infrared and other wireless media.

Many other configurations of computing devices, applications, data sources, and data distribution systems may be employed to analyze system alerts using deltas instead of individual alerts. Furthermore, the networked environments discussed in FIG. 4 are for illustration purposes only. Embodiments are not limited to the example applications, modules, or processes.

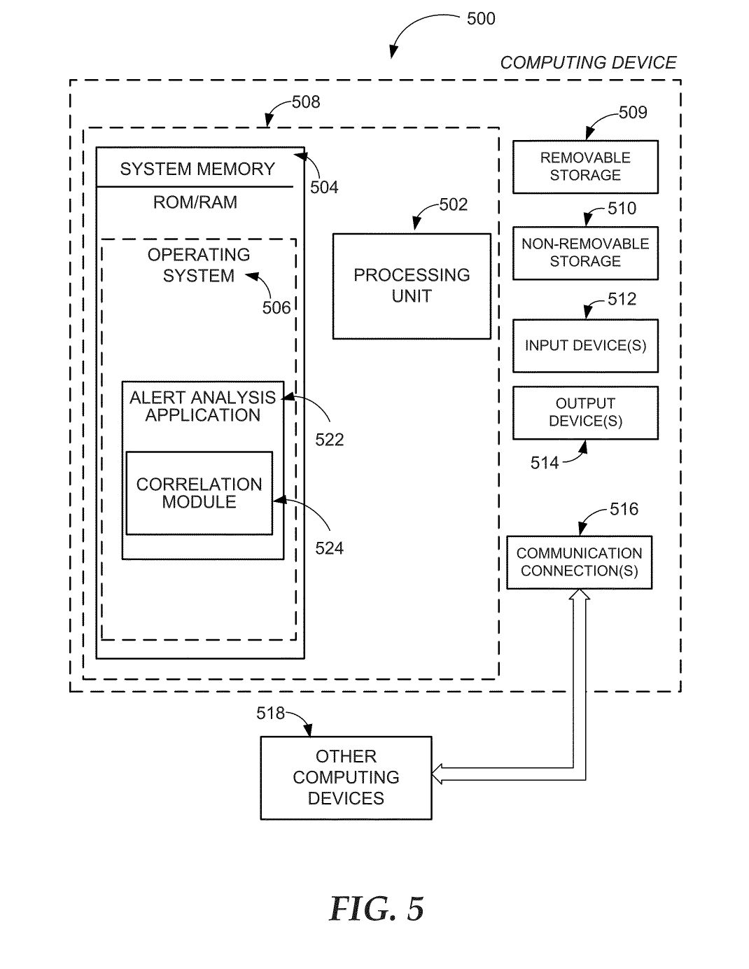

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any of the example devices discussed herein, and may include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 506 suitable for controlling the operation of the platform, such as the WINDOWS®, WINDOWS MOBILE®, or WINDOWS PHONE® operating systems from MICROSOFT CORPORATION of Redmond, Wash. The system memory 504 may also include one or more software applications such as alert analysis application 522 and correlation module 524.

The correlation module 524 may operate in conjunction with the host service or alert analysis application 522 and rather than treating alerts individually, may deal with alerts as pairs and using the deltas between alert pairs as the data to be analyzed by machine-learning techniques. Alert pairs may be generated by comparing each alert to other alerts surrounding it in time. The deltas for each pair may be computed, and those sets of deltas analyzed to determine difference values in absolute numeric terms. A threshold may then be applied to determine alerts within a certain distance to represent a correlation. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, an optical capture device for detecting gestures, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications, other directory or policy servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

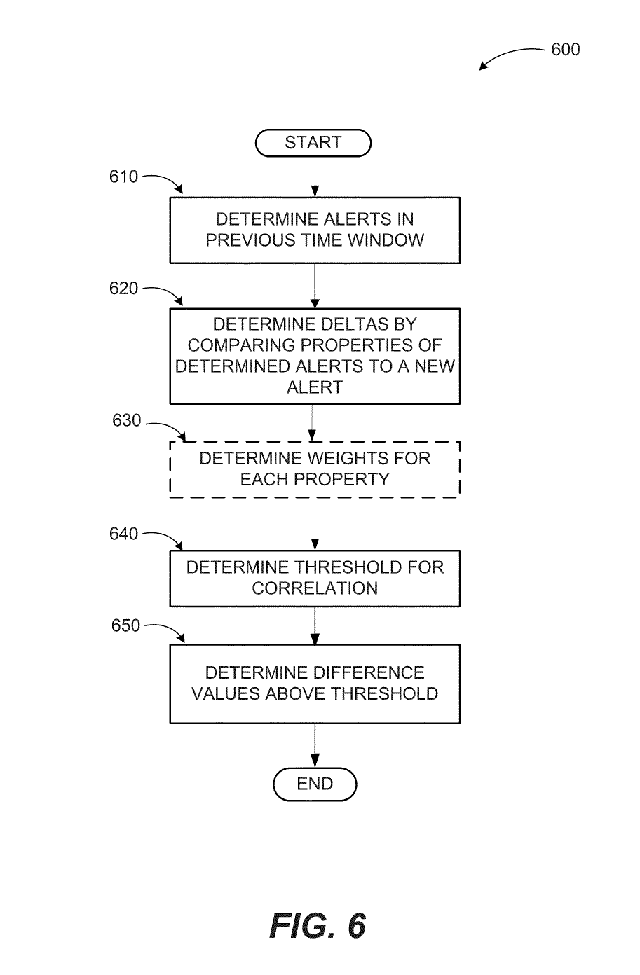

FIG. 6 illustrates a logic flow diagram for a process of correlating system alerts via deltas, according to embodiments. Process 600 may be implemented as part of a monitoring system or application.

Process 600 begins with operation 610, where a monitoring and/or analysis application may determine alerts surrounding a new alert in time, for example, with a predefined time window such as an hour, a day, etc. At operation 620, deltas may be determined by comparing properties of determined alerts to the new alert. For ease of computation, the difference values may be expressed in absolute numeric terms.

At optional operation 630, weights may be determined for properties of the alerts. The weights may be predefined, manually input, or learned through a machine-learning technique. At operation 640, a threshold may be determined to determine correlation. The threshold may be applied to the deltas, for example using a distance to represent correlation. Values above the threshold may be presented at operation 650 as alerts related to each other.

Alert correlations may also be used to actually suppress redundant alerts rather than simply report on them such that redundant alerts may not reach an end user unnecessarily. Moreover, alerts may be handled manually or automatically. The correlation process described herein may be implemented in both scenarios.

The operations included in process 600 are for illustration purposes. Analyzing system alerts through correlation using deltas according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device to provide analysis of system alerts using deltas, the method comprising:
detecting a new alert;
determining a plurality of alerts within a predefined time period prior to the detection of the new alert;
determining deltas between the new alert and each of the plurality of alerts;
computing a difference value for each delta;
determining a correlation threshold; and
identifying alerts whose difference value is above the correlation threshold as related to each other.

2. The method of claim 1, further comprising:
presenting the alerts identified as related to the new alert along with the new alert to one of a support engineer and a system health monitoring service.

3. The method of claim 1, wherein determining the deltas comprises:
comparing one or more properties of each of the plurality of alerts to corresponding properties of the new alert.

4. The method of claim 3, wherein determining the deltas comprises:
computing a numeric value for each delta within a predefined range.

5. The method of claim 4, wherein the predefined range is between 0 and 1, 0 indicating identical properties and 1 indicating distinct properties.

6. The method of claim 3, further comprising:
assigning a weight to each property.

7. The method of claim 6, further comprising:
determining the weight employing a machine-learning algorithm.

8. The method of claim 7, wherein the machine-learning algorithm is a gradient descent algorithm.

9. The method of claim 1, further comprising:
computing the difference value for each delta based on determining a distance between alerts associated with each delta.

10. The method of claim 1, further comprising:
determining the correlation threshold through one of a user input, a predefined threshold value, and a machine-learning algorithm.

11. The method of claim 1, further comprising one of:
receiving a user feedback to confirm a validity of a presented correlation; and
inferring the user feedback from user interactions with a system processing the alerts to confirm the validity of the presented correlation.

12. A computing device to provide analysis of system alerts using deltas, the computing device comprising:
a memory;
a processor coupled to the memory, the processor executing an alert analysis application, wherein the processor is configured to:
detect a new alert;
determine a plurality of alerts within a predefined time period prior to the detection of the new alert;
determine deltas between the new alert and each of the plurality of alerts;
compute a difference value for each delta;
determine a correlation threshold;
identify alerts whose difference value is above the correlation threshold as related to each other employing a machine-learning algorithm; and
present the alerts identified as related to the new alert along with the new alert to one of a support engineer and a system health monitoring service.

13. The computing device of claim 12, wherein the system alerts are issued and analyzed in a hosted communication service that facilitates one or more of: an email exchange, an instant message exchange, a text message exchange, a social or gaming network invite, a social or gaming network update, a blog post, a forum post, a tweet, an audio communication, a video communication, an online meeting, data sharing, document sharing, and application sharing.

14. The computing device of claim 12, wherein the alerts are issued by one or more of a hardware component of the system and a software component of the system.

15. The computing device of claim 12, wherein the processor is further configured to:
present the alerts identified as related to the new alert along with the new alert on a user interface that enables user feedback regarding a validity of a correlation between the presented alerts; and
adjust the machine-learning algorithm employed to identify the alerts as related.

16. The computing device of claim 12, wherein the processor is configured to:
assign weights to each property of the alerts; and
compute the difference value for alert pairs based on the deltas and weights associated with each property employing one of a Euclidian distance function and a sigmoidal function.

17. The computing device of claim 12, wherein the processor is configured to:
store each identified relationship and corresponding alert pair.

18. A computer-readable memory device with instructions stored thereon to provide analysis of system alerts using deltas, the instructions comprising:
detecting a new alert;
determining a plurality of alerts within a predefined time period prior to the detection of the new alert;
determining deltas between the new alert and each of the plurality of alerts by comparing one or more properties of each of the plurality of alerts to corresponding properties of the new alert;
assigning a weight to each property;
computing a difference value for each delta;
determining a correlation threshold;
identifying alerts whose difference value is above the correlation threshold as related to each other; and
presenting the alerts identified as related to the new alert along with the new alert to one of a support engineer and a system health monitoring service.

19. The computer-readable memory device of claim 18, wherein the instructions further comprise:
computing a numeric value for each delta within a predefined range, wherein the predefined range is between 0 and 1, 0 indicating identical properties and 1 indicating distinct properties.

20. The computer-readable memory device of claim 18, wherein the instructions include:
adjusting the predefined time period based on one or more of user input and a machine-learning algorithm.
